(19) United States
(12) Patent Application Publication
(10) Pub. No.: US 2017/0132773 A1
(43) Pub. Date: May 11, 2017

(54) METHOD AND APPARATUS FOR PROVING AND DETERMINING AN INTEGRITY STATUS OF AN OUTER PACKAGING

(71) Applicant: Hicof Inc., Wollerau (CH)

(72) Inventor: Sascha Toedtli, Bach (CH)

(21) Appl. No.: 15/411,347

(22) Filed: Jan. 20, 2017

Related U.S. Application Data
(63) Continuation of application No. PCT/EP2015/066755, filed on Jul. 22, 2015.

(30) Foreign Application Priority Data
Jul. 29, 2014 (EP) 14178938.8

(51) Int. Cl. G06T 7/00; G01N 21/88

(52) U.S. Cl. CPC G06T 7/001; G01N 21/8806; G06T 7/0008; G06T 2207/30108

(57) ABSTRACT

A method and apparatus for proving an integrity status of an outer packaging. The outer packaging covers an item and includes a modification of a foil provided for the outer packaging. A picture of a section of the outer packaging is recorded and a reference to a feature of the modification of the foil is analyzed. The integrity status of the original outer packaging is proved by storing the reference with respect to the original outer packaging for further use, wherein the outer packaging is uniquely identifiable by using the reference. The integrity status of suspect outer packaging is determined by comparing the reference of the suspect outer packaging with the reference of the original outer packaging. This allows using the outer packaging itself to be used for determining its integrity and may, thus, support avoiding a willful tampering or manipulation of the outer packaging.

### CROSS REFERENCE TO RELATED APPLICATIONS

This is a continuation of application no. PCT/EP2015/066755 filed Jul. 22, 2015 which claims priority from EP 14178938.8 filed Jul. 29, 2014, the disclosures of both of which are incorporated herein by reference.

### BACKGROUND

### 1. Technical Field

The present disclosure relates to a method and an apparatus for proving an integrity status of an outer packaging as well as for determining the integrity status of a suspect outer packaging. The disclosure further relates to a computer program for performing the mentioned methods as well as to a data carrier having a data structure stored thereon, which, after loading into a computer or a computer network, is capable of executing the methods.

### 2. Description of the Related Art

The determination of the integrity status of a packaging is a technology known from the cigarette industry, such as in EP 0 330 495 A2, EP 0 902 275 A1, EP 1 420 381 A1, DE 10 2008 062 370 A1, WO 2001/024141 A1, WO 2001/030654 A1, or WO 2001/079092 A1, where it is, generally, used for determining defects during manufacture of an outer packaging for cigarettes comprising a transparent folded wrapper, but may also be employed in other areas, in particular in the food, medical, pharmaceutical, and/or cosmetic industry as, for example, in U.S. Pat. No. 3,899,295, U.S. Pat. No. 5,515,159, US 2012/013734 A1, or U.S. Pat. No. 7,142,707 B2.

For this purpose, U.S. Pat. No. 5,515,159 discloses an on-line inspection of opaque, translucent and transparent elastomer sealed flexible and semi-rigid packaging seals, wherein, in case of highly reflective opaque seals of various elastomers and colors, low incident angle structured side lighting is used to locate and define the seal and highlight defects within the sealed area. For transparent, i.e. highly light transmissive seals, back lighting of the packaging is further provided in order to locate and classify defects within the seal boundaries. The images generated are used to determine whether the outer packaging is accepted, possibly accepted, or rejected based upon the quality of the seal area and the presence of any defects in the seal boundaries.

U.S. Pat. No. 7,142,707 B2 describes an apparatus comprising a computer component which receives at least one image of a packaging material, wherein the computer component employs an analysis of the image to determine a packaging integrity of the packaging materials by comparing optical features, such as transmittance, absorption, fluorescence excitation, or deformation of the packaging or of graphics, or by an identification of bright regions within the outer packaging, in particular by using low-angle incidence of radiation.

WO 2001/030654 A1 proposes to use at least one label, wherein the label comprises, in an encoded form, at least one characteristic feature of a packed article, in particular of a packed group of cigarettes, wherein the label will be destroyed when opening the outer packaging, such as for taking a cigarette, wherein the encoded form is compared with the characteristic feature in order to reveal falsifications by deviations or recurring identical matches. Alternatively, WO 2001/024141 A1 describes providing individual articles, such as each item in a group of cigarette, with characteristic, externally detectable markings, wherein the markings are encoded and applied to the outer packaging, in particular in form of a label, wherein a comparison between the externally detectable markings and the encoded form on the outer packaging allows determining its integrity.

EP 0 330 495 A2 discloses a packet inspection system being capable of high speed sensing and evaluation of packaging integrity. The system is capable of measuring predetermined parameters of an outer packaging, e.g. cigarette packages, comparing the measured parameters with predetermined values, evaluating from the measured parameters the integrity of the outer packaging and determining whether such an outer packaging is acceptable or, alternatively, should be rejected. Herein, the measured packaging is compared to a reference packaging to achieve a qualitative evaluation of the packaging structure with respect to wrapper centering alignment, wrapper placement skew, closure stamp alignment, closure stamp skew, flap closure, wrapper foil condition, and packaging shape. A similar inspection system is disclosed in EP 0 902 275 A1.

However, the known state of the art, on one hand, requires an additional piece, such as a seal, which may itself be subject to manipulation in order to demonstrate integrity of the outer packaging and/or, on the other hand does not allow pursuing the respective good over the whole supply chain.

### SUMMARY

The present disclosure provides a method and an apparatus for proving an integrity status of an outer packaging as well as for determining the integrity status of a suspect outer packaging, which at least partially overcome the problems and shortcomings of such methods and devices known from the state of the art.

The present disclosure also provides a method and an apparatus for determining the integrity status of the packaging which allows pursuing the respective items covered within the outer packaging over the whole supply chain without any requirement to apply a separate piece for demonstrating its integrity, such as a seal, to the outer packaging in order to be able to detect a manipulation of the outer packaging.

Disclosed herein is a method and an apparatus for proving an integrity status of an outer packaging, a method and an apparatus for determining the integrity status of a suspect outer packaging, a computer program for performing one or more of the methods according to the present disclosure and by a data carrier having a data structure stored thereon, which, after loading into a computer or computer network, is capable of executing one or more of the methods according to the present disclosure. Preferred embodiments, which might be realized in an isolated fashion or in any arbitrary combination thereof, are described herein.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it should be understood that various terms used throughout this disclosure and claims should not receive a singular interpretation unless it is made explicit herein. By way of non-limiting example, the terms “item,” “modification,” “foil,” to name just a few, should be interpreted when appearing in this disclosure and claims to mean “one or more” or “at least one.” All other terms used herein should be similarly interpreted unless it is made explicit that a singular interpretation is intended.

Further, as used herein, the terms “preferably”, “more preferably”, “particularly”, “more particularly” or similar terms are used in conjunction with optional features, without restricting alternative possibilities. Thus, features introduced by these terms are optional features and are not intended to restrict the scope of the invention in any way. The invention may, as the skilled person will recognize, be performed by using alternative features. Similarly, features introduced by “in an embodiment” or similar expressions are intended to be optional features, without any restriction regarding alternative embodiments of the invention, without any restrictions regarding the scope of the invention and without any restriction regarding the feasibility of combining the features introduced in such way with other optional or non-optional features of the invention.

Generally speaking, the present methods and apparatuses are suitable for proving and determining an integrity status of an outer packaging. As further used herein, the term “outer packaging” refers to an enclosure which may at least partially, preferably completely, cover an item, such as a good or a product, in particular for storage, distribution, and sale. In particular contrast to other packages, such as an inner packaging, the outer packaging may be accessible and, especially, visible from the outside around the respective outer packaging. In this respect it may be mentioned that, particularly depending on the specific field in which the outer packaging is employed, the outer packaging may also be denoted by other terms which are commonly used for such kinds of objects, such as “package”, “packing”, “wrap”, “wrapper”, “wrapping”, “bundle”, sealing“, or “vacuumization”. Applying an outer packaging may be performed due to a number of different purposes, including but not limited to providing a protection for at least one item comprised within the outer packaging, such as a protection from mechanical, physical, chemical, biological or environmental interference, such as from shock, vibration, electrostatic discharge, radiation, dust, vapor, atmospheres, or contamination, or from interference with other substances, for improving transport properties, such as improved convenience, portion control, containment, or agglomeration of individual items, for providing a suitable substrate for a transmission of information, in particular by attaching respective labels to the outer packaging, as well as for improving security and marketing performances.

With particular regard to the present disclosure, the outer packaging may be considered as an original outer packaging as long as the outer packaging may be genuine and not tampered. In contrast hereto, a suspect outer packaging may be considered as an outer packaging which may or which may not be identical with the original outer packaging but which may have been tampered with for any reason, such as to remove at least one item from the outer packaging or to replace at least one of the original items by a counterfeit item which may allegedly create an impression as being identical to the original item. A willful tampering or manipulation may particularly occur in a case in which the at least one item comprised in the outer packaging may be of some esthetic or monetary value, such as with jewelry, watches, pieces of art, rare artifacts, microprocessors, or pharmaceuticals. In some cases it may be easy to identify a suspect outer packaging since the suspect outer packaging might differ with respect to any property from the original outer packaging, such as in a case where traces may be present which may be indicative of a breaking and a subsequent reclosing of the respective outer packaging. On the other hand, the tampering of the outer packaging may have been accomplished in a quality that the suspect outer packaging may not show any evidence, whether obvious or difficult to access, which would make it distinguishable from the original outer packaging in this way. Consequently, a suspect outer packaging might be one of a group consisting of the original outer packaging and of the tampered outer packaging.

As further used herein, the “item” may be any physical object which may at least partially, preferentially completely, covered by an outer packaging as described above and/or below. Hereby, it is of no particular relevance whether the item itself may be of any value or whether the item, such as a document or an inner packaging, refers to or comprises another item which may be of some value, either in a commercial view, a personal view, or any other view. In a number of cases the inner packaging of any kind may comprise at least one item. First, the item itself may be of a consistence, such as a gel, a liquid, a gas, or of any other form which may not exhibit a steady solid form, that a particular kind of inner packaging may be required for storing, transporting, trading, and any other action referring to the item. Second, the item may be furnished with any kind of inner packaging, for example, for any commercial or trading reason, such as for improving storability, durability, stability, or keeping properties of the item, for equipping the item with an inner packaging which comprises a specific style or design, particularly for transport or storage reasons, or for improving the optical appearance of the item such as for esthetic or trading reasons. Third, there may also be legal or statutory reasons which may require the item to be furnished with an inner packaging, such as for medical drugs. Particularly within the pharmaceutical industry, but not limited thereto, each substance which may comprise, within a first respect, a solid body, such as a powder, a pill, a tablet, or a preparation, within a second respect, a liquid, such as a liquid formulation, an emulsion, or a serum, or, within a third respect, a gas, such as an aerosol, are comprised in at least in one inner packaging, which may further be comprised itself in at least one additional packaging, which is usually referred to as the outer packaging as described elsewhere. Thus, the item may refer to the physical object itself, to a label, a document, or any other article which may accompany the physical object, or to at least the one inner packaging which may comprise the physical object. Consequently, the item may not only be selected from the physical object itself but also from an accompanying article or from any other object which may be employed as the inner packaging in form of a primary packaging for the physical object, such as a bottle, a syringe, a vial, an ampoule, a carpule, a blister, and/or in form of a secondary packaging such as a cardboard box, a folding box, or a hangtag. In this regard, it is of no relevance whether the inner packaging completely or only partially encloses the object.

With regard to the present disclosure, the at least one item may preferably also be arranged on at least one pallet. As used herein, the term “pallet” may refer to a primarily flat structure comprising at least one deckboard which is supported by at least two, but usually three or four, stringers, wherein the structure is configured for supporting at least one item, preferably a number of items which can be treated together as a so-called “bundle”, in particular for the purpose of providing a stable substrate whereon the item or the bundle of items may be located, stored or moved, such as by using a forklift or a pallet jack. In general, the pallet may comprise a mechanical stable material, in particular wood, metal, or a suitable plastic, cardboard or paper. In this preferred embodiment, wherein the at least one item is placed on the at least one pallet, the outer packaging may not only cover the at least one item but, additionally, may cover the at least one pallet at least partially, such as the top of the pallet adjoining to then location where the at least one item is placed. This kind of arrangement might be useful for further protecting and securing the at least one item. However, it is emphasized here that the present disclosure is equally applicable to items, such for food, medicals, pharmaceuticals, and/or cosmetics, which may be covered by the outer packaging without first being placed on at least one pallet.

In further accordance with the present disclosure, at least one foil is provided for manufacturing the outer packaging. As used herein, the term “foil”, which may also be denoted as a “film”, relates to a quasi-two dimensional body, wherein the quasi-two dimensional body may particularly exhibit a considerable extension in two dimensions, which are usually known as “length” and “width” of the foil, whereas the third dimension of the body, usually referred to as a “thickness” of the foil, exhibits an extension being much smaller than the considerable extension with respect to the other two dimensions. As a typical example, the thickness of a specific foil may, thus, be in the range from 1 μm to 100 μm, whereas the width may be in a range from 10 cm to 2.5 m while the length may range from 1 m to 100 m, in some cases practically only depending on the size of a so-called “endless tape” or “continuous tape”, which constitutes a foil being rolled-up for further use by unrolling the required portion. In order to be able to provide the foil as endless or continuous tape, the thickness of the foil may usually be required to stay below an experimentally determined value; otherwise it may not be possible to roll up the foil. Generally, the foil is selected from one or more of: a plastic foil, which might predominantly exhibit clear, lucent, or (semi-)transparent properties; a metal foil, preferably an aluminum foil, which might particularly show highly reflecting properties; a sheet of paper. However, other choices may be appropriate under specific circumstances.

Thus, the outer packaging is formed by using the at least one foil in order to at least partially, in particular completely, enclose the at least one item and, if applicable, also at least the top of the pallet on which the at least one item is placed. In some cases it might be advantageous to employ more than one foil to cover the respective item, such as in a case where the width of the foil turns out to be too small or where the thickness of a single foil may not be sufficient for providing enough stability of the outer packaging. In order to accomplish an optimal quality as possible of the outer packaging, in particular to further improve the stability of the complete packaging and, thus, to avoid an early opening, the at least one item, especially for larger items, may additionally be secured with at least one strapping which could be further affixed around the complete packaging comprising the at least one item and the corresponding outer packaging.

By forming the outer packaging through applying the at least one foil to the at least one item, at least one modification is introduced into the at least one foil. As used herein, the term “modification” of the at least one foil refers to a development of at least one feature within the foil which was not present in the foil prior to the modification. In a particular preferred embodiment, the at least one modification of the foil is introduced into the foil by at least one of wrapping, stretching, shrinking, or otherwise putting the foil around the at least one item and, if applicable, around at least the top of the pallet on which the at least one item is placed. Herein, the foil which may be used for covering the at least one item may be taken from a roll of foil, but the foil may equally be provided in the form of a pouch or sleeve. However, other kinds of foil may be feasible for specific purposes.

As used herein, the term “wrapping” refers to covering at least a part of the at least one item with a foil which is designated at least as a part of the outer packaging.

As further used herein, the term “stretching” or “stretch wrapping” refers to covering the at least one foil, in particular where the foil comprises a plastic foil, around the at least one item, wherein an inherent elastic recovery of the foil allows keeping the at least one item tight within the boundaries of the foil. For this purpose, the foil may comprise a linear low-density polyethylene, usually abbreviated to “LLDPE”, since LLDPE usually exhibits high adhesive properties together with a considerable tensile strength. However, other types of polyethylene (PE) or polyvinylchloride (PVC) may also be employed. In a particular preferred embodiment, a so-called “palletizer” may be used, i.e. an apparatus which provides automatic means, such as robotics, for placing the at least one item onto a pallet and, subsequently, covering the at least one item and, if applicable, at least the top of the pallet with the foil in form of a stretch wrap in order to provide the desired outer packaging.

In contrast hereto, the term “shrinking” or “shrink wrapping” refers to applying at least one foil, which particularly comprises a plastic foil, rather loosely around the at least one item and, subsequently, curing the plastic film with heat in order to accomplish a shrinking of the foil in a manner that it, preferentially tightly, covers the at least one item at least partially, in particular completely. For this purpose, heat may be applied with a heat gun, such as a hand-held gas or electric heat gun. Especially for a mass production, the at least one item at least partially covered with the film may be provided on a conveyor belt for passing through an appropriate heat tunnel. The plastic foil which may be used as shrink wrap usually comprises a polyolefin, but other polymers, such as PVC, PE, or polypropylene (PP), may also be employed. In particular for food, a coextrusion and a lamination which may comprise a number of different layers are preferably used as shrink wraps. The packaging may, thus, comprise a thin plastic film which may be used for covering items, such as food, for keeping them fresh over a longer period of time, in particular by using a shrink wrap. For covering food items, these kinds of packaging may also be denoted as “plastic wrap”, “food wrap”, “cling film”, or “cling wrap”.

As mentioned above, at least one label may be attached to the outer packaging. As used herein, a “label” refers to a substrate which is attached on the outer packaging and which may present data in alphanumeric, graphic or electronic form that is used for providing information which is related to the at least one item as comprised within the packaging and/or the outer packaging itself. The information as presented on the at least one label may include one or more of addresses, such as at least one sending and/or at least one receiving party, codes, such bar codes, data matrix codes QR codes, Electronic Data Interchange (EDI), identification codes or other product codes, such as a universal product code, a Serial Shipping Container Code (SSCC), Radio-Frequency Identification (RFID) labels, country of origin labels, registration marks, trademarks, symbols for product certifications, proof of purchase marks, notes providing conformance to a regulation, such as to a weight and measures accuracy regulation, e.g. a CE marking, environmental and/or recycling symbols, such as a recycling code, a resin identification code and/or a “Green Dot”, special information symbols for hazardous or dangerous goods, food contact material symbols, such as an oval-shaped EC identification mark, health marks for food safety, quality insurance signs, calibration and/or troubleshooting cues. As will be described below in more detail, at least one label attached to the outer packaging may equally be employed for storing at least one reference with regard to the original outer packaging for further use in a method for determining the integrity status of a suspect outer packaging.

The substrate of the label may preferably be shaped as an adhesive tag or sticker, as such comprising a thin sheet of paper or plastic affixed to a double-sided adhesive layer, which may be attached to the packaging by using a manual, a semi-automatic or, preferably, an automatic label dispenser. Preferably, the label may exhibit an optical contrast with regard to the packaging to which it is attached to, in particular by employing a thin sheet of a preferably white or bright substrate exhibiting the advantageous optical contrast to the material of the packaging which, in case of a plastic foil, might predominantly show clear, lucent, or (semi-)transparent properties, or in case of metal foil, preferably an aluminum foil, might particularly exhibit highly reflecting properties.

As already mentioned above, by a modification process comprising the forming the outer packaging through applying the at least one foil to the at least one item, the foil itself undergoes at least one modification. As a result of the modification process, the foil comprises at least one feature which is related to the modification as introduced by the modification process into the foil. According to a continuous observation of the modification process and its results as well as being particularly suited for being used in the methods according to the present disclosure, the at least one feature of the modification of the foil is preferably selected from one or more of:
at least one fold, i.e. an undulating shape, over at least one specific section of the outer packaging being introduced into the foil as a result of the modification; and/or
at least one variation of a transparency and/or of a color of the at least one foil with regard to the respective property of the foil prior to the modification;
at least one property of at least one edge, wherein the edge may be comprised within the outer packaging due to a respective wrapping of the foil around the at least one item;
at least one stain which may, in general unintentionally, be introduced into at least one location on the foil by the modification;
at least one variation of the features over at least one specific section of the outer packaging, in particular, if at least two features are present, at least one variation of the at least two features.

As used herein, the term “section” may actually refer to a part of the outer packaging, but, depending on the selected perspective, may also relate to one, two, or three partial or whole sides of the outer packaging as being recorded in a single picture.

With particular regard to the present disclosure, the term “fold” may refer to an undulated shape which might have developed in a part of the outer packaging, in particular after stretching or shrinking the foil which may, particular tightly, cover the at least one item as comprised by the outer packaging. Herein, the undulated shape may exhibit a sinusoidal, a wavelike or a rippled form particularly perpendicular with respect to a surface of the foil in a portion of the outer packaging. The ripples within the undulated shape may, in some case over a considerable area, form a regular sinusoidal variation of the at least one plastic film comprised within the packaging. However, overtones which might comprise a sequence of sine waves of different amplitudes as well as irregular patterns may also be observable within the areas where the undulation has developed.

Alternatively or in addition, the at least one foil used as the outer packaging may exhibit a variation with regard to the transparency and/or color of the foil when compared with the respective property of the foil before it underwent the modification. In particular due to a stretching and/or shrinking of the foil and depending on its inherent material properties during the modification process, the thickness of the foil may be slightly reduced within at least one specific area which may lead to a change of the optical properties of the foil within the specific area. Alternatively or in addition, the foil may be folded, pleated, creased, wrinkled, dragged or pushed together during the modification process which may result in a further change of the transparency and/or color of the foil. These kinds of changes are particularly obvious for a plastic foil but comparable features may also be observed in foils comprising a metal or a paper. Consequently, the transparency and/or the color of the foil which might be altered as a result of the modification may, thus, be observable as one of the features which particularly are suitable for the purpose of the present disclosure. However, further optical features, such as an observation of a phase and/or a polarization shift might as well be employed.

Alternatively or in addition, the at least one foil used as the outer packaging may exhibit at least one edge comprised within the outer packaging due to a respective wrapping of the quasi-two dimensional foil around the at least one three-dimensional item. With regard to the present disclosure, a location, a form, or a reflectivity of the edge may be suitable to be employed as the at least one feature of the modification. However, other properties of the edge may also be applicable for this purpose.

Alternatively or in addition, the at least one foil may exhibit at least one stain which may, in general unintentionally, be introduced into at least one location on the foil by touching and modifying the foil during manufacturing the outer packaging covering the at least one item. The outer packaging may, thus, exhibit at least one location where an amount of dirt, sweat, color residues, or a fingerprint, such as of a human fingertip or of a robot being employed within a palletizer, may be placed. With particular regard to the present disclosure, a location, a form, or a reflectivity of the stain may, further, suitably be employed as the at least one feature resulting from the modification. However, the stain may exhibit other properties which may also be applicable for this purpose.

Alternatively or in addition, the at least one variation of the features, whether previously mentioned or not, may be observable over at least one specific section of the outer packaging. This selection might preferably be applicable to distinguish contents of different sections of the outer packaging, such as sections in which a considerable number of various features may be observed, and other sections in which a only very few or no features may be present. As will be explained below in more detail, a density of features within a specific section may also be evaluated by applying respective evaluation methods to the respective section.

In a first aspect, the present disclosure relates to a method for proving an integrity status of an original outer packaging. As used herein, the term “proving” relates to acquiring and storing technical features which characterize the respective outer packaging in a manner that the outer packaging may, subsequently, be uniquely identifiable by using the stored characteristic technical features which relate to the outer packaging.

As further used herein, the “integrity status” of an outer packaging provides a value which defines whether a suspect outer packaging may be considered as the original outer packaging whose integrity is under question or not, i.e. an original or a tampered outer packaging. As further used herein, the outer packaging may be considered as the original outer packaging as long as the outer packaging itself may not be altered. Consequently, the method for determining the integrity status may, within a first respect, comprise a method for determining a verification of a suspect outer packaging or, within a second respect, comprise a method for determining a falsification of a suspect outer packaging, depending on the purpose and/or circumstances under which the method may be performed. In other words, the present method may be performed in a case in which it is desired to confirm the integrity of the suspect outer packaging. On the other hand, the present method may also be applied in a case in which the integrity of the suspect outer packaging may be discarded for any reason. Furthermore, the method may also be used under circumstances in which it may be desired to find an answer to an open question whether the outer packaging under investigation may be the true original outer packaging to be verified or whether the suspect outer packaging may be a tampered outer packaging pretending to be the original outer packaging.

In this regard, the present method may deliver a Boolean value which may be designated by TRUE or FALSE, by 1 or 0, or by any other designation and which may comprise the integrity status of the outer packaging determined by application of the present methods. Alternatively, the present method may deliver an absolute value or, more particular, a relative value, such as a percentage of accordance between two pictures under comparison, which may comprise an indication about the integrity status of the outer packaging determined by application of the present methods. For this purpose, it may be preferable to define a threshold, above which the integrity may be assumed and below which the integrity may be denied, or vice-versa. In addition, therefrom a result, for example, in form of a Boolean value as described above may be acquired. This value, whether Boolean or not, may further be employed by a user of the present methods for any purpose, e.g. as an entry into a specific database which may comprise such kind of values, for producing an optical signal or an audio signal or a signal of any other kind upon determining the suspect outer packaging to be a tampered outer packaging, or for separating an object which comprises the suspect outer packaging which may have been falsified by the method from an inspection line. However, the present method may be applied under various other circumstances and for any other purpose, which may particularly be based upon any specific need of the user.

According to the present disclosure, the method comprises the following steps step a) to c). Herein, the steps a) to c) are preferably performed in the given order, commencing with step a) and finishing with step c), still, other orders may be feasible. Further, it may be possible to perform two or more of the steps simultaneously or in an overlapping fashion. Further, it may also be feasible to perform one, two or more of the steps repeatedly, not depending on the fact whether other steps may be equally repeated. Further, additional steps may be comprised, irrespective whether the additional steps may or may not be mentioned in the following.

According to step a) of the present method for proving the integrity status of an original outer packaging, at least one picture of at least one section of the outer packaging is recorded. As further used herein, the “picture” may comprise an optical image of a section of the outer packaging which is recorded by using an optical system. Hereby, the picture may describe a one- or a two-dimensional representation comprising a number of pixels in each dimension which together form the picture of the respective section of the outer packaging, thus, constituting a basis for a further evaluation of the picture in order to analyze at least one reference to the at least one feature of the at least one modification of the at the least one foil with regard to the outer packaging comprising the at least one item.

In this regard, the proving and/or determining of the integrity may require a picture of the section of the outer packaging which may exhibit a reasonable quality and a sufficient resolution, which may be of particular importance for a further comparison of two distinct pictures, such as in step d) as described below, a comparison between a picture of the respective section of the suspect outer packaging and a hereto distinct picture of the supposed or alleged corresponding original outer packaging. Since in case of a poor quality and/or a low resolution of the picture of the section of the outer packaging, the present method may provide distorted results, such that a tampered outer packaging may be mistaken for the original outer packaging, it may, therefore, be necessary to ensure, before analyzing a recorded picture of the respective section of the outer packaging, that the picture may comprise a reasonable quality and resolution.

In particular for this purpose, it may be preferred to perform a transformation of the at least one picture as recorded for at least one section of the outer packaging. Herein, the term “transformation” may refer to at least one alteration of at least one element of the picture, such as a pixel or a further constituent of the picture, or the complete picture after the recording of the picture. In a particularly preferred embodiment, the transformation may comprise one or more of the following transformation processes:
adjusting the picture, in particular in a manner that the at least one recorded section of the outer packaging actually comprises at least one feature of interest of the at least one modification of the at the least one foil;
rearranging a spatial orientation of the picture, in particular by aligning the picture in a manner that the at least one recorded section of the outer packaging comprising the at least one feature of interest constitutes a preferably rectangular shape, preferably as by spatially orienting the picture with respect to at least one recurring element, preferably by cropping at least one side of the picture, in particular, if applicable, by removing a part of the picture which shows the at least one pallet or a part thereof;
removing a spatial distortion within the picture, in particular with respect to a perspective geometry, preferably as by employing known methods for eliminating distortions;
performing a binary alteration of the picture, in particular by employing local binary patterns (LBP);
performing a color classification transition in the picture, in particular by a transition from one color space to a further color space, such as from an RGB (red, green, blue) color space to an HSV (hue, saturation, value) color space.

In a preferred embodiment, a spatial orientation of the picture may be performed during the transformation process with particular regard to one or more of the following recurring elements: one or more edges of the outer packaging, which may, preferably, further be highlighted by respective marks, such as by a black, a white, or a color mark; a particular arrangement of at least one label, preferably of more than one label, on the surface of the outer packaging; one or more gaps between the at least two, but usually three or four, stringers which are adapted to support the at least one deckboard of the pallet. In this regard it may be preferable to rely on known features and, in addition, to employ a neural network which may be capable of both machine learning and pattern recognition.

By employing at least one of the mentioned transformation processes, a good comparability of at least two distinct pictures may, thus, be achieved. In addition, further mechanisms may be applied to ensure a good readability of the features comprised within the image, in particularly with regard to the contrast of the image. In the field of image processing various methods exist which may be applied to determine the quality of a given optical image, such as a detection of a blur of the image or a frequency analysis of the image.

In a preferred embodiment, the optical system employed for performing a method according to the present disclosure may comprise at least one element which may be selected from the group comprising: a camera, a flatbed scanner, a bar code hand-scanning device, a cell or a cellular phone, a laptop webcam, a smartphone, a tablet computer. However, any other optical system comprising a resolution which may be sufficient to resolve the characteristic features within the outer packaging may also be used.

According to step b), at least one reference to at least one feature of the at least one modification of the foil is analyzed in the picture. In this regard, the at least one feature may, preferably, be selected from one or more of: at least one fold within the outer packaging; at least one variation of a transparency and/or a color of the outer packaging; at least one property of at least one edge within the outer packaging; at least one stain as comprised within the outer packaging; at least one variation of the features over at least one specific section of the outer packaging.

According to the present disclosure, the at least one reference may be selected from one or more of: the at least one picture of the at least one section of the outer packaging, wherein the at least one section comprises the at least one feature; at least one quantity acquired for the at least one feature as comprised in the at least one picture of the at least one section of the outer packaging. Thus, the at least one reference may comprise the at least one picture in a form as recorded of the at least one section of the outer packaging, wherein the at least one feature of interest may be comprised. In a particular preferred embodiment, the at least one reference may, particularly, refer to the at least one picture after having performed a transformation of the at least one picture, wherein the transformation may comprise one or more of the transformation processes as described above, particularly in order to provide a good comparability of at least two distinct pictures, such as during the subsequent step d).

Alternatively or in addition, the at least one reference may, preferably, be derived from a quantity which may be related to the at least one feature developed in the outer packaging as a result of the at least one modification of the foil as described above and/or below in more detail. For this purpose, a numerical value for this quantity related to one or more features as developed in the outer packaging due to the modification of the foil may be employed, wherein the quantity may also be denoted as “individual imperfection profile” of the outer packaging. However, other denominations are possible.

In a preferred embodiment, the at least one quantity as acquired for the at least one feature is obtained from the picture of the at least one section of the outer packaging by using one or more of:
a threshold, in particular a limit below which respective characteristics, such as a color, in the picture may be disregarded;
a feature extraction technique, in particular a Hough Transformation and/or a Watershed Filter, wherein the term “feature extraction technique” may generally relate to a method for reducing an acquired set of information into a reduced set of information in a manner that the reduced set comprises the desired feature;
an edge detection operator, in particular a Canny Transformation or a filter according to Sobel, Prewitt, Roberts, Marr-Hildreth and/or Haralick, wherein the term “edge detection operator” may generally refer to a method for identifying at least one location in an image where a brightness or an intensity may change sharply and, thus, exhibits discontinuities;
a texture classification technique, in particular applying local binary patterns (LBP), wherein the term “texture classification technique” may generally concern a method for extracting a shape, such as a mark or a stain, from a textured image;
a process for approximating periodic features, in particular a Fourier analysis, more particular a Fast Fourier Transformation (FFT), wherein the periodic features may particularly be represented or approximated by a sum of at least one trigonometric function.

In this regard, it may be advantageous to select a specific section within the outer packaging which may exhibit a variation which might be above or below an average variation to be observable over at least one side of the outer packaging. Further, it might be especially useful to count the number of folds within the selected section and to identify its corresponding properties in more detail by employing the Canny Transformation and/or one or more of the above-mentioned filters. A similar procedure may be applicable to stains within the at least one selected section. Alternatively or in addition, at least two selected sections may be compared, in particular with regard to their corresponding transparency and/or color within the selected section which may be indicative of the respective thickness of the modified foil within the selected section. Alternatively or in addition, at least two selected sections may be compared, in particular with regard to a variation and/or density of features within the at least one selected section which may be indicative of a perturbation or a disturbance within the selected section. However, other kinds of deriving a numerical value for the quantity related to one or more features developed in the outer packaging as a consequence of the modification of the foil may be suitable.

As a result, the at least one reference to at least one feature of the at least one modification of the foil with respect to the original outer packaging has, thus, been acquired during step b). The at least one reference with respect to the original outer packaging is, during subsequent step c), stored as the integrity status of the original outer packaging for further use, in particular at some time in the future, in order to be employed to determine on this basis the integrity status of a suspect outer packaging.

In a particular preferred embodiment, the at least one reference with regard to the original outer packaging may be stored for further use by one or more of:
applying the at least one reference to the outer packaging, such as in a form of a code, e.g. a bar code, a data matrix code, a QR code, as applied to a label attached to the outer packaging as described above in more detail;
generating a database record for the corresponding outer packaging, wherein the database record may at least comprise the at least one reference with regard to the original outer packaging and might, further, comprise a further reference to the original outer packaging, such as the SSCC code;
if applicable, storing the at least one reference in a separate storage device, such as an RFID chip, a USB chip, or a magnetic stripe, wherein the separate storage device may be attached to the at least one pallet.

In a further preferred embodiment, the database record as generated during step c) may be transmitted to a database via one or more channels selected from: a wireless data transmission, a wire bound data transmission, a transmission via a computer network. Hereby, the exact details and manners of the transmission are of little relevance as long as the generated database record may be inserted into the database for further use during step d) of the method for determining the integrity status of the suspect outer packaging. In addition, by storing the further reference to the outer packaging, such as the SSCC code, too, it may, thus, be possible to easier identify the corresponding reference to the respective suspect outer packaging.

In a particularly preferred embodiment, the method for proving the integrity status of an outer packaging may be part of a packaging process for packaging the at least one item, irrespective whether being placed on a pallet or not, into an outer packaging. This kind of performance may particularly ensure that data which may later be required for a determination of the integrity status of the suspect outer packaging may be stored within the database with little or no time delay, preferably directly within the packaging line. Such an approach may particularly be useful for decreasing the manipulation of an outer packaging.

In a further aspect, the present disclosure relates to a method for determining the integrity status of a suspect outer packaging. The method according to the present disclosure comprises steps a), b) and d). These steps are preferably performed in the given order, commencing with step a) and finishing with step d), still, other orders may be feasible. Further, it may be possible to perform two or more of the steps simultaneously or in an overlapping fashion. Further, one or more steps may be performed repeatedly, depending or not whether other steps are equally repeated. The method may further comprise one or more additional steps, whether mentioned herein or not.

For further details to the method for determining the integrity of a suspect outer packaging, reference may be made to the disclosure of the method for proving the integrity of an original outer packaging, as disclosed above and/or below. In particular, both step a) related to recording a picture of a section of the outer packaging and b) related analyzing a reference to a feature of a modification of a foil in the picture have already been disclosed there. Accordingly, the at least one reference with respect to the suspect outer packaging is, thus, acquired. However, in contrast to the method for proving the integrity of an original outer packaging, the corresponding result of step b) may, during subsequent step d), be employed to determine the integrity status of the suspect outer packaging on this basis. With regard to the at least one reference, the disclosure of the method for proving the integrity of the original outer packaging, as disclosed above and/or below, may also be taken into account.

According to step d), the at least one reference with respect to the suspect outer packaging is compared with the at least one reference with respect to the original outer packaging as obtained during step b) within a comparing step. Hereby, a comparison of the at least one reference with respect to the suspect outer packaging with the at least one reference with respect to the original outer packaging allows determining the integrity status of the suspect outer packaging. As further used herein, “comparing” includes making a comparison between the at least one reference with respect to the suspect outer packaging with the at least one reference with respect to the original outer packaging with regard to their identity but also taking into account a tolerance level within which the integrity of the suspect outer packaging may be still assumed. Introducing a tolerance level may particularly allow taking into account inevitable adverse effects, such as deterioration, ageing, dirt, color residues or wear, which may affect the outer packaging during storage and/or transport.

As already described above in more detail, the at least one reference may be selected from one or more of: the at least one picture of the at least one section of the outer packaging, wherein the at least one section comprises the at least one feature; at least one quantity acquired for the at least one feature as comprised in the at least one picture of the at least one section of the outer packaging. Thus, the comparing according to step d) may comprise comparing the at least one picture of the at least one section of the suspect outer packaging with the at least one picture of the at least one section of the original outer packaging either in a form as recorded, or, in particularly preferred, after a transformation which comprises one or more of the transformation processes as described above has been applied to the respective pictures, particularly in order to provide a good comparability between the at least two distinct pictures. Alternatively or in addition, the comparing according to step d) may comprise comparing at least one quantity related to the at least one feature in the suspect outer packaging, such as the individual imperfection profile of the suspect outer packaging, with at least one quantity related to the at least one feature in the original outer packaging, such as the individual imperfection profile of the original outer packaging.

Since a further modification of the foil as comprised within the outer packaging may, thus, further modify the foil with regard to at least one reference and may, consequently, alter the at least one reference with respect to the outer packaging, a comparison according to step d) may indicate a tampering of the outer packaging in a time interval between the at least two distinct pictures which may be recorded for the same section of the corresponding outer packaging.

The present method for determining the integrity status of the suspect outer packaging may, further, comprise a transmission step by which, preferably after one or more of the method steps step a) or step b), data may be transferred to a data processing unit via a computer network in such a manner that the further steps, after the transmission, may be performed by the data processing unit, wherein the integrity status of the suspect outer packaging may be returned by the data processing unit. This transmitting step may particularly be performed by at least one control unit which may be adapted to perform or to have performed at least method step a) as well the data transmission. The control unit may comprise a computer or a micro-computer, wherein the micro-computer may be part of the optical system, of a system which may control the optical system, or of a system which may be in connection with the optical system. Which kinds of data are transmitted by the control unit to the data processing unit may particularly depend at which stage during the performance of the present method the actual data transmission takes place. As an example, after step a) the at least one picture of the at least one section of the outer packaging as recorded by the optical system may be transferred to the data processing unit on which the further steps b) and d) may be performed until the integrity status of the suspect outer packaging may be determined and returned to the at least one control unit. As a further example, steps a) and b) may be performed locally until the control unit may transmit the at least one reference determined for the suspect outer packaging to the data processing unit where only the remaining comparison step d) may be performed until the integrity status of the suspect outer packaging may be determined and returned to the at least one control unit. In this particular embodiment it might be advantageous that the database may be one or more of comprised within the processing unit or operationally connected to the data processing unit.

In a further aspect of the present disclosure, a proving apparatus for proving the integrity of an original outer packaging is disclosed. In this regard, reference may be made to the description above and/or below referring to the corresponding method. The proving apparatus comprises at least parts A) to C), which may be arranged in any suitable order. Further, additional parts may be comprised in the proving apparatus which are not mentioned in the following. The parts may be part of one combined apparatus or centralized unit or may be combined in different apparatuses or de-centralized units, wherein the apparatuses are adapted to interact in any suitable fashion, such as by wire-bound communication and/or wireless communication.

Herein, Part A) of the proving apparatus comprises a recording device being configured for recording at least one picture of at least one section of the outer packaging, whereas part B) comprises an analysis device configured for analyzing in the picture at least one reference to at least one feature of the at least one modification of the at the least one foil. Part C) of the proving apparatus comprises a storing device for storing the at least one reference with respect to the original outer packaging, wherein the storing device may comprise a label being attached to the outer packaging, a database device for generating a database record for the outer packaging, or, if applicable, a storage attached to the at least one pallet on which the at least one item may be placed. Hereby, the database record may comprise the at least one reference with respect to the original outer packaging as well as further reference to the outer packaging, such as an SSCC code. In a particularly preferred embodiment, the proving apparatus is configured to perform the method for proving the integrity of the original item as described above and/or below. For further details of the proving apparatus, reference may be made to the method for proving the integrity status of an original outer packaging as described elsewhere.

In a preferred embodiment, the proving apparatus may be part of a packaging apparatus for furnishing the at least one item with an outer packaging. This kind of embodiment may be particularly useful for strictly combining the packaging of the at least one item with the apparatus which generates the database record being related to the item. This arrangement may particularly allow ensuring that the at least one reference as stored on the item, in the database record and/or, if applicable, with the pallet may actually be related to the respective original outer packaging. Such a strong physical relationship of the mentioned devices may be particularly intended to reduce the risk of disappearing with relation to items of some value as comprised within the outer packaging.

In a further aspect of the present disclosure, a determining apparatus for determining the integrity status of a suspect outer packaging is disclosed. In this regard, reference may be made to the description above and/or below referring to the corresponding method as well as to the proving apparatus. According to the present disclosure, the determining apparatus at least comprises at least parts A), B) and D), which may be assembled in any suitable fashion. Further, additional parts may be comprised within the authentication apparatus which may or may not be mentioned in the following. The parts may be part of one combined apparatus or centralized unit or may be combined in different apparatuses or de-centralized units, wherein the apparatuses are adapted to interact in any suitable fashion, such as by wire-bound communication and/or wireless communication.

As described above for the proving apparatus, Part A) of the determining apparatus comprises a recording device being configured for recording at least one picture of at least one section of the outer packaging, whereas part B) comprises an analysis device configured for analyzing in the picture at least one reference to at least one feature of the at least one modification of the at the least one foil. However, in contrast to the proving apparatus, part D) of the determining apparatus comprises a comparing device configured for comparing the at least one reference with respect to the suspect outer packaging with the at least one reference with respect to the original outer packaging as stored as the integrity status of the original outer packaging for further use in a storing device according to part C) as described elsewhere in this description. By this comparison, the integrity status as defined above of the suspect outer packaging is determined. In a particularly preferred embodiment, the determining apparatus may be configured to perform the method for determining the integrity status of the suspect outer packaging as described above and/or below. For further details of the determining apparatus, reference may be made to the proving apparatus as well as to the method for determining the integrity status of a suspect outer packaging as described elsewhere.

In a particularly preferred embodiment, the determining apparatus may be further adapted to control the transmission of data to a data processing unit. In this regard, the transmission of the data may be performed via one or more transmission means selected from a wireless data transmission, a wire bound data transmission, and/or a transmission via a computer network. Further details concerning the data transmission, the data and the data processing unit may be found elsewhere in this description.

The present application further discloses and proposes a computer program, including computer executable instructions for performing both the method for proving the integrity of the original outer packaging and the hereto related method for determining the integrity status of the suspect outer packaging, when the program is executed on a computer or a computer network. Preferentially, the computer program may be stored on a computer readable data carrier. In this regard, the disclosure further describes a data carrier having a data structure stored thereon, wherein the data structure, after loading into a computer or a computer network, is capable of executing any or all methods as disclosed herein. As further used herein, a computer may comprise any device which may be capable of storing data and/or performing calculating steps and/or instructing steps. By way of example, this definition may not only include work stations and notebooks but also application-specified integrated circuits (ASICs) and field-programmable gate arrays (FPGAs).

Preferably, referring to the computer-implemented aspects of the present disclosure, one or more of the method steps or even all of the method steps of any or all methods disclosed herein may be performed by using a computer or a computer network. Thus, generally, any of the method steps including provision and/or manipulation of data may be performed by using a computer or a computer network. Generally, these method steps may include any of the method steps.

The disclosure further describes and proposes a computer program including computer-executable instructions for performing any or all methods according to the present disclosure in one or more of the embodiments enclosed herein when the program is executed on a computer or computer network. Preferentially, the computer program may be stored on a computer-readable data carrier. Thus, preferably, one, more than one or even all of method steps as indicated above may be performed by using a computer or a computer network, preferably by using a computer program.

The disclosure further describes and proposes a computer program product having program code means, in order to perform any or all methods according to the present disclosure in one or more of the embodiments enclosed herein when the program is executed on a computer or computer network. Preferentially, the program code means may be stored on a computer-readable data carrier.

Further, the disclosure describes and proposes a data carrier having a data structure stored thereon, which, after loading into a computer or computer network, such as into a working memory or main memory of the computer or computer network, may execute any or all methods according to one or more of the embodiments disclosed herein.

The disclosure further describes and discloses a computer program product with program code means stored on a machine-readable carrier, in order to perform any or all methods according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier. Preferentially, the computer program product may be distributed over a data network.

Finally, the disclosure proposes and describes a modulated data signal which contains instructions readable by a computer system or computer network, for performing any or all methods according to one or more of the embodiments disclosed herein.

Preferably, referring to the computer-implemented aspects of the disclosure, one or more of the method steps or even all of the method steps of any or all methods according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

The methods and devices according to the present disclosure are considerably distinguished from known methods and devices according to the state of the art and, thus, provide a number of advantages with regard to the state of the art. In addition to the well-known advantages of unit loads, particularly those which employ stretch wraps around palletized items, which are usually considered to be improved stability of products, more efficient handling and storage, some degree of dust and moisture protection, and some degree of tamper resistance and resistance to packaging pilferage, the present disclosure allows that the outer packaging itself may be used for determining the integrity of the outer packaging.

This further purpose may equally be employed for one or more items which may be covered in a plastic foil, such as cellophane, without being placed on a pallet.

In this regard, the present methods for proving and determining the integrity status of an outer packaging may, respectively, be employed for a fast and still reliable investigating of a plurality of outer packaging along the supply chain with respect to their integrity status and may, thus, help avoiding a willful tampering or manipulation in a case wherein the at least one item comprised in the outer packaging may be of some esthetic or monetary value, such as with jewelry, watches, pieces of art, rare artifacts, microprocessors, or pharmaceuticals. In contrast to the state of the art, the present methods for proving and determining the integrity status of an outer packaging may, respectively, are based on the observation that the outer packaging itself may comprise tamper-evident features which may be employed to help indicate tampering. Thus, in addition to other known measures which are commonly used for improved tamper resistance in order to deter the tampering of an outer packaging, the modifications introduced into the foil which, according to the present disclosure, constitute the outer packaging may advantageously be employed to help reducing risks of pilferage as well as theft and resale of items comprised in the corresponding outer packaging.

Summarizing the findings of the present disclosure, the following embodiments are preferred:

Embodiment 1: A method for proving an integrity status of an original outer packaging, wherein the outer packaging covers at least one item, wherein the outer packaging is formed by at least one modification of at least one foil provided for the outer packaging, wherein the proving comprises acquiring and storing at least one reference to at least one feature introduced by the at least one modification into the at the least one foil, wherein the outer packaging is uniquely identifiable by using the at least one reference, the method comprising the following steps:
a) recording at least one picture of at least one section of the outer packaging;
b) analyzing in the picture the at least one reference to at least one feature introduced by the at least one modification into the at the least one foil; and
c) storing the at least one reference with respect to the original outer packaging as the integrity status of the original outer packaging for further use, in particular in a method for determining the integrity status of a suspect outer packaging.

Embodiment 2: A method for determining an integrity status of a suspect outer packaging, wherein the outer packaging covers at least one item, wherein the outer packaging is formed by at least one modification of at least one foil provided for the outer packaging, wherein the outer packaging is suspect of a tampering, the method comprising the following steps:
a) recording at least one picture of at least one section of the outer packaging;
b) analyzing in the picture at least one reference to at least one feature introduced by the at least one modification into the at the least one foil being suspect of a further modification by the tampering of the outer packaging; and
d) comparing the at least one reference with respect to the suspect outer packaging with at least one reference with respect to an original outer packaging, in particular as stored for further use according to step c) of the preceding embodiment, by which comparison the integrity status of the suspect outer packaging is determined.

Embodiment 3: The method according to any one of the preceding embodiments, wherein the foil is selected from one or more of: a plastic foil, a metal foil, preferably an aluminum foil; a sheet of paper.

Embodiment 4: The method according to any one of the preceding embodiments, wherein the at least one modification of the at least one foil is introduced into the foil by at least one of wrapping, stretching, or shrinking the foil around at least the at least one item.

Embodiment 5: The method according to any one of the preceding embodiments, wherein the at least one feature of the at least one modification of the at the least one foil to which the at least one reference is related is selected over the at least one picture of the at least one section of the outer packaging from one or more of: at least one fold; at least one variation of a transparency and/or a color; at least one property of at least one edge; at least one stain; at least one variation of the feature, in particular with respect to a further feature.

Embodiment 6: The method according to the preceding embodiment, wherein the at least one fold comprises an undulated shape developed in a part of the outer packaging during the modification, wherein the undulated shape particularly exhibits a sinusoidal, a wavelike or a rippled form, wherein the undulated shape is preferably perpendicular to a surface of the foil in a portion of the outer packaging.

Embodiment 7: The method according to any one of the preceding two embodiments, wherein the at least one stain comprises at least one modification in at least one location on the outer packaging, wherein an amount of dirt, sweat, color residues, or a fingerprint, in particular of a human fingertip or of a robot being employed within a palletizer, is placed in the at least one location.

Embodiment 8: The method according to any one of the preceding embodiments, wherein the at least one reference is selected from one or more of: the at least one picture of the at least one section of the outer packaging, wherein the at least one section comprises the at least one feature; at least one quantity acquired for the at least one feature as comprised in the at least one picture of the at least one section of the outer packaging.

Embodiment 9: The method according to any one of the preceding embodiments, wherein a transformation of the at least one picture as recorded for at least one section of the outer packaging is performed.

Embodiment 10: The method according to the preceding embodiment, wherein the transformation comprises one or more of the following transformation processes: adjusting the picture of the at least one section of the outer packaging; rearranging a spatial orientation of the picture; removing a spatial distortion within the picture; performing a binary alteration of the picture; performing a color classification transition in the picture.

Embodiment 11: The method according to the preceding embodiment, wherein the adjusting of the picture of the section of the outer packaging is performed in a manner that the at least one section of the outer packaging comprises at least one feature of interest of the at least one modification of the foil.

Embodiment 12: The method according to any one of the two preceding embodiments, wherein the rearranging of the spatial orientation of the picture is performed by aligning the picture in a manner that the at least one recorded section of the outer packaging comprising the at least one feature of interest constitutes a preferably rectangular shape.

Embodiment 13: The method according to the preceding embodiment, wherein the rearranging of the spatial orientation of the picture is obtained by spatially orienting the picture with respect to at least one recurring element.

Embodiment 14: The method according to the preceding embodiment, wherein the recurring element is selected from one or more of: one or more edges of the outer packaging, wherein the edge is preferably highlighted by marks, in particular by a black, a white, or a color mark; an arrangement of at least one label on the surface of the outer packaging; at least one gap between stringers supporting at least one deckboard of a pallet.

Embodiment 15: The method according to any one of the three preceding embodiments, wherein the rearranging of the spatial orientation of the picture is performed by cropping at least one side of the picture.

Embodiment 16: The method according to the preceding embodiment, wherein the cropping of the at least one side of the picture comprises removing a part of the picture showing at least one pallet or a part thereof.

Embodiment 17: The method according to any one of the seven preceding embodiments, wherein the removing of the spatial distortion is performed with respect to perspective geometry, in particular by employing a method for eliminating distortions in an image.

Embodiment 18: The method according to the preceding ten embodiments, wherein the at least one quantity acquired for the at least one feature is obtained from the picture of the at least one section of the outer packaging by using one or more of: a threshold, a feature extraction technique, an edge detection operator, a texture classification technique, a process for approximating periodic features.

Embodiment 19: The method according to the preceding embodiment, wherein the feature extraction technique comprises a Hough Transformation and/or a Watershed Filter.

Embodiment 20: The method according to any one of the preceding two embodiments, wherein the edge detection operator comprises a Canny Transformation or a filter according to Sobel, Prewitt, Roberts, Marr-Hildreth and/or Haralick.

Embodiment 21: The method according to any one of the preceding three embodiments, wherein the texture classification technique comprises an application of local binary patterns (LBP).

Embodiment 22: The method according to any one of the preceding four embodiments, wherein the process for approximating periodic features comprises a Fourier analysis, in particular a Fast Fourier Transformation (FFT).

Embodiment 23: The method according to any one of the preceding embodiments, wherein the at least one reference is stored for further use by one or more of: applying the at least one reference to the outer packaging, in particular as a code, preferably as a bar code, a data matrix code, or a QR code, on a label attached to the outer packaging; generating a database record in a database which at least comprises the at least one reference; storing the at least one reference in a storage device, wherein the storage device is attached to at least one pallet.

Embodiment 24: The method according to the preceding embodiment, wherein the database record is transmitted to and/or retrieved from a database via one or more of: a wireless data transmission, a wire-bound data transmission, a transmission via a computer network.

Embodiment 25: The method according to the preceding embodiment, wherein a transmission of data to a data processing unit is performed via a computer network, wherein the further steps after the transmission are performed by the data processing unit, wherein the integrity status of the suspect outer packaging is returned by the data processing unit, wherein the data are preferably transmitted by at least one control unit, the control unit being adapted to perform or to having performed at least method step a), wherein the data transmission preferably takes place after one or more of the method steps step a) or step b).

Embodiment 26: The method according to any one of the two preceding embodiments, wherein a transmission of data to a data processing unit is performed via a computer network, wherein the further steps after the transmission are performed by the data processing unit, wherein the integrity status of the suspect outer packaging is returned by the data processing unit.

Embodiment 27: The method according to the preceding embodiment, wherein the data are transmitted by at least one control unit, the control unit being adapted to perform or to having performed at least method step a).

Embodiment 28: The method according to any one of the three preceding embodiments, wherein the at least one reference with respect to the original item is stored in a database, wherein the database is one or more of comprised within the data processing unit or operationally connected to the data processing unit.

Embodiment 29: The method according to the preceding embodiment, wherein the record of the database comprises a composite number containing the at least one reference and a further reference to the outer packaging.

Embodiment 30: The method according to any one of the preceding embodiments, wherein the at least one item is arranged on at least one pallet, wherein the outer packaging covers the at least one item and at least a part of the pallet.

Embodiment 31: The method according to any one of the preceding embodiments, wherein the item is selected from the group consisting of: a physical object; an accompanying article, such as a label, or a document; a primary packaging, such as a bottle, a syringe, a vial, an ampoule, a carpule, a blister; a secondary packaging, such as a folding box, a hangtag, a cardboard box.

Embodiment 32: The method according to any one of the preceding embodiments, wherein the method is part of a packaging process for packaging the at least one item.

Embodiment 33: A proving apparatus for proving an integrity status of an original outer packaging, wherein the outer packaging covers at least one item, wherein the outer packaging is formed by at least one modification of at least one foil provided for the outer packaging, wherein the proving comprises acquiring and storing at least one reference to at least one feature introduced by the at least one modification into the at the least one foil, wherein the outer packaging is uniquely identifiable by using the at least one reference, the proving apparatus comprising:
A) a recording device configured for recording at least one picture of at least one section of the outer packaging;
B) an analyzing device configured for analyzing in the picture the at least one reference to at least one feature introduced by the at least one modification into the at the least one foil;
C) a storing device for storing the at least one reference with respect to the original outer packaging as the integrity status of the original outer packaging for further use, in particular in a determining apparatus for determining the integrity status of a suspect outer packaging.

Embodiment 34: The proving apparatus according to the preceding embodiment, wherein the proving apparatus is configured to perform the method for proving the integrity status according to any one of the preceding embodiments referring to a method for proving the integrity status of on original outer packaging.

Embodiment 35: The proving apparatus according to the preceding embodiment, wherein the proving apparatus is part of a packaging apparatus for packaging the at least one item.

Embodiment 36: A determining apparatus for determining an integrity status of a suspect outer packaging, wherein the outer packaging covers at least one item, wherein the outer packaging is formed by at least one modification of at least one foil provided for the outer packaging, wherein the outer packaging is suspect of a tampering, the determining apparatus comprising:
A) a recording device configured according to the embodiment referring to a proving device;
B) an analyzing device configured according to the embodiment referring to a proving device;
D) a comparing device configured for comparing the at least one reference with respect to the suspect outer packaging with at least one reference with regard to an original outer packaging, in particular as acquired from Part C) according to the preceding embodiment, by which comparison the integrity status of the suspect outer packaging is determined.

Embodiment 37: The determining apparatus according to the preceding embodiment, wherein the determining apparatus is configured to perform the method for determining the integrity status according to any one of the preceding embodiments referring to a method for determining an integrity status of a suspect outer packaging.

Embodiment 38: The determining apparatus according to any of the preceding embodiments referring to an apparatus, wherein the recording device comprises an optical system, wherein the optical system comprises at least one element which is selected from the group consisting of: a camera, a flatbed scanner, a bar code hand-scanning device, a laptop webcam, a cell phone, a smartphone, a tablet computer.

Embodiment 39: The determining apparatus according to any one of the preceding embodiments referring to a determining apparatus, wherein the determining apparatus is adapted to control a transmission of data to a data processing unit, wherein the transmission of the data is performed via one or more of: a wireless data transmission, a wire-bound data transmission, a transmission via a computer network.

Embodiment 40: A computer program including computer-executable instructions for performing the methods according to any one of the preceding method embodiments, when the program is executed on a computer or computer network.

Embodiment 41: A data carrier having a data structure stored thereon, wherein the data structure, after loading into a computer or computer network, is capable of executing the methods according to any one of the preceding method embodiments.

Embodiment 42: A computer or computer network comprising at least one processor, wherein the processor is adapted to perform the method according to one of the embodiments described in this description.

Embodiment 43: A computer loadable data structure that is adapted to perform the method according to one of the embodiments described in this description while the data structure is being executed on a computer.

Embodiment 44: A computer program, wherein the computer program is adapted to perform the method according to one of the embodiments described in this description while the program is being executed on a computer.

Embodiment 45: A computer program comprising program means for performing the method according to one of the embodiments described in this description while the computer program is being executed on a computer or on a computer network.

Embodiment 46: A computer program comprising program means according to the preceding embodiment, wherein the program means are stored on a storage medium readable to a computer.

Embodiment 47: A storage medium, wherein a data structure is stored on the storage medium and wherein the data structure is adapted to perform the method according to one of the embodiments described in this description after having been loaded into a main and/or working storage of a computer or of a computer network.

Embodiment 48: A computer program product having program code means, wherein the program code means can be stored or are stored on a storage medium, for performing the method according to one of the embodiments described in this description, if the program code means are executed on a computer or on a computer network.

Further optional features and embodiments will be disclosed in more detail in the subsequent description of preferred embodiments. Therein, the respective optional features may be realized in an isolated fashion as well as in any arbitrary feasible combination, as the skilled person will realize. The scope of the invention is not restricted by the preferred embodiments.

### BRIEF DESCRIPTION OF THE DRAWINGS

The above mentioned and other features of this invention, and the manner of attaining them, will become more apparent and the invention itself will be better understood by reference to the following description taken in conjunction with the accompanying drawings, wherein several embodiments are schematically depicted in the Figures.

FIG. 1 schematically depicts a well-known process for furnishing a number of items on a pallet with a foil in order to provide an outer packaging;

FIG. 2 presents a schematic overview over features of an outer packaging;

FIG. 3 shows a schematically overview over a preferred embodiment of a proving apparatus for proving an integrity of an original outer packaging; and

FIG. 4 presents a schematic layout of a preferred embodiment of a determining apparatus for determining an integrity status of a suspect outer packaging.

Corresponding reference characters indicate corresponding parts or functionally comparable elements throughout the several views. Although the exemplification set out herein illustrates embodiments of the invention, the embodiments disclosed below are not intended to be exhaustive or to be construed as limiting the scope of the invention to the precise forms disclosed.

### DETAILED DESCRIPTION

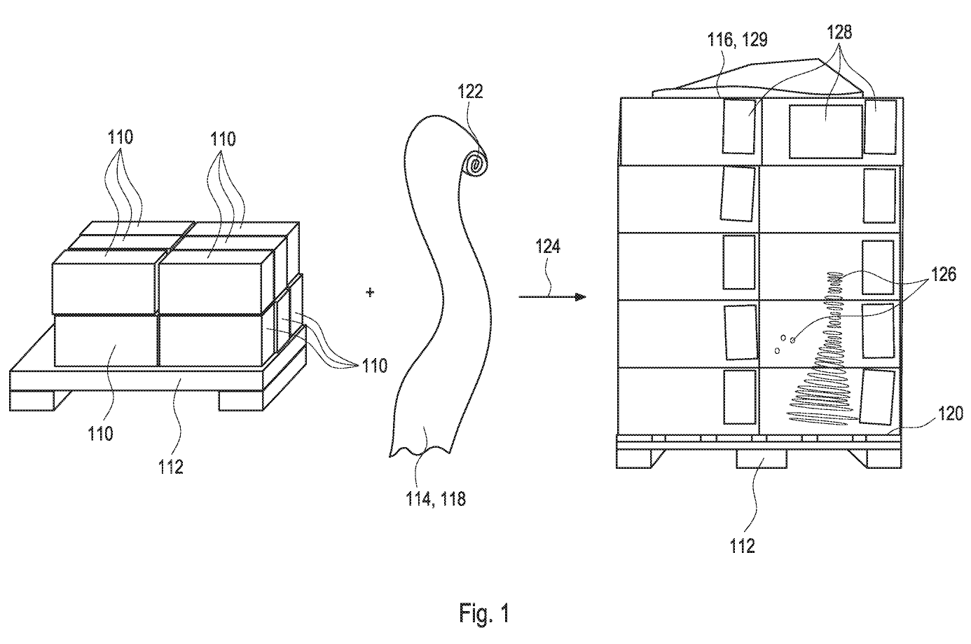

FIG. 1 schematically depicts a well-known process for furnishing a number of items 110 which are placed on a pallet 112 by employing a foil 114 in order to provide an outer packaging 116 which, in this preferred example, covers both the items 110 and at least the top part 120 of the pallet 112. However, it is emphasized here that the present disclosure is equally applicable when the number of items 110, such as food, medicals, pharmaceuticals, and/or cosmetics, may only be covered by the foil 114 in order to provide the outer packaging 116 without any requirement to be placed on the pallet 112.

In this particular example, the foil 114 which is being used for providing the outer packaging 116 is a transparent plastic foil 118 which is, preferentially, taken from a roll 122 of so-called endless or continuous tape by unrolling a required portion of the foil 114. According to the present disclosure, however, other kinds of foil, such as a metal foil, preferably an aluminum foil, or a sheet of paper, are equally applicable. By forming the outer packaging 116 through applying the foil 114 in order to cover at least the items 110, at least one modification 124 is introduced into the foil 114, wherein the modification 124 of the foil 114 causes a development of one or more features 126 within the foil 114 which were not present in the foil 114 prior to the modification 124.

Further, in this particular example, the modification 124 of the foil 114 is introduced here into the foil 114 by one or more of wrapping, stretching, or shrinking the foil 114 around the items 110 and the top 120 of the pallet 112 on which the items 110 are placed. In this regard, the plastic foil 114, 118 is preferably first wrapped around the items 110 as well as the top 120 of the pallet 112 by covering the items 110 and the top 120 of the pallet 112 with the foil 114 and, subsequently, stretched by employing an inherent elastic recovery of the plastic foil 114, 118 which allows keeping the items 110 as well as the top 120 of the pallet 112 tight within the boundaries of the plastic foil 114, 118. Especially for a mass production, a palletizer, i.e. an apparatus providing automatic means, such as robotics, for placing the items 110 onto the pallet 112 and, subsequently, covering the item 110 and the top 120 of the pallet 112 with the plastic foil 114 may be employed for providing the desired outer packaging 116.

Alternatively, the plastic foil 114, 118 may rather loosely applied around the items 110 and the top 120 of the pallet 112 and, subsequently, cured with an application of heat in order to accomplish a shrinking of the plastic foil 114, 118 in a manner that it completely, preferentially tightly, covers the items 110 and the top 120 of the pallet 112. Especially in mass production, the items 110 and the pallet 112 on which the items 110 are placed may be provided for achieving this purpose on a conveyor belt for passing through an appropriate heat tunnel.

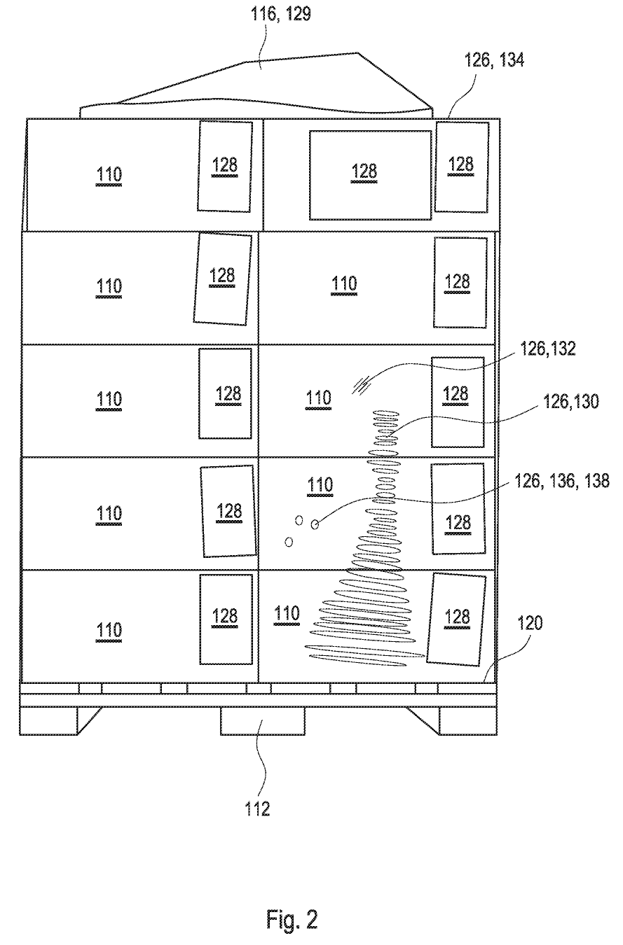

As already mentioned above and irrespective of the actual process as applied for performing the modification 124, the modification 124 of the foil 114 causes a development of one or more features 126 within the foil 114 which were not present in the foil 114 prior to the modification 124 and which will be explained with regard to FIG. 2 in more detail.

In addition, one or more labels 128 may be attached to the outer packaging 116, wherein the labels 128 provide an optical contrast with regard to the outer packaging 116. For this purpose, the labels 128 are attached onto the outer packaging 116 for presenting data in alphanumeric, graphic or electronic form for providing information generally being related to the items 110 as comprised within the outer packaging 116. Herein, the information may include addresses, bar codes, identification codes or other product codes, in particular an SSCC code, RFID labels, country of origin labels, registration marks, trademarks, symbols for product certifications, proof of purchase marks, notes providing conformance to a regulation, information symbols for hazardous or dangerous goods, food contact material symbols, quality insurance signs, calibration and/or troubleshooting cues, and others.

FIG. 2 presents a more detailed schematic overview over the various features 126 as comprised within one side 129 of the outer packaging 116 which may, preferably, be used in the methods according to the present disclosure. As a result of the modification 124 of the plastic foil 114, 118, the plastic foil 114, 118, which constitutes the outer packaging 116 comprises in this particular example, a number of folds 130 are introduced into the plastic foil 114, 118 in an undulating shape over at least one specific section of the outer packaging 116. Further, the plastic foil 114, 118, which here constitutes the outer packaging 116, comprises in this particular example a variation 132 of a transparency and color of within at least one specific section of the outer packaging 116 with regard to the respective property of the plastic foil 114, 118 prior to the modification 124. Furthermore, edges 134 have been formed within the outer packaging 116 in this particular example mainly due to the wrapping of the plastic foil 114, 118 around the items 110 and the top 120 of the pallet 112. Moreover, stains 136 in the form of a fingerprint 138 have, unintentionally, been applied in this particular example onto at least one location on the plastic foil 114, 118 which constitutes the outer packaging 116 after the modification 124. However, other kinds of features 126, such as stains 138 arising from sweat or from color residues, such as from unintentionally touching a human being or a colored object, respectively, may result from the modification 124, too.

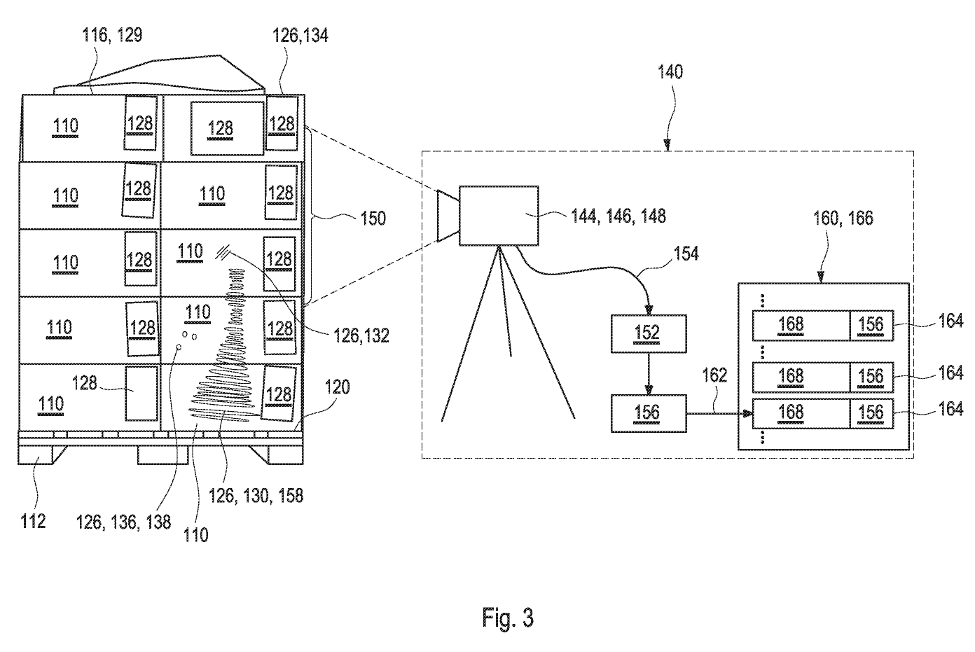

FIG. 3 schematically displays a preferred embodiment of a proving apparatus 140 which is particularly configured for performing the method for proving the integrity status 142 of an original outer packaging 116. Herein, the proving apparatus 140 comprises a camera 144 as an example of an optical system which is employed as a recording device 146 being configured for recording one or more pictures 148 of one or more sections 150 at one or more sides 129 of the outer packaging 116. In this respect, it may particularly be useful to record a picture of four sides 129 of the outer packaging 116 which are perpendicular to the pallet 112. Alternatively, it may be sufficient to record only a picture of a single side 129 of the outer packaging 116 which comprises the majority of the features 126.

Further, the proving apparatus 140 comprises an analysis device 152 which is configured for analyzing the pictures 148 of the sections 150 for retrieving at least one reference to one or more features 126 as introduced during the modification 124 of the plastic foil 114, 118 which constitutes the outer packaging 116. For this purpose, the pictures 148 of the sections 150 are transferred from the recoding device 146 to the analysis device 152 by a transmission line 154 which may be wire-bound, wire-less or within a computer network. Accordingly, at least one of the pictures 148 of the sections 150 may be used as the at least one reference. Herein, a transformation of the pictures 148 may be performed, wherein the transformation may comprise one or more of the following transformation processes: adjusting the picture of the at least one section of the outer packaging; rearranging a spatial orientation of the picture; removing a spatial distortion within the picture; performing a binary alteration of the picture; performing a color classification transition in the picture.

Alternatively or in addition, from a quantity which is related to the features 126 as developed in the outer packaging 116 as a result of the modification 124 of the plastic foil 114, 118, an individual packaging profile 156 of the outer packaging 116 may be derived as a corresponding numerical value which may constitute or contribute to the at least one reference.

In a preferred embodiment as employed in this example, the individual imperfection profile 156 of the outer packaging 116 is acquired by employing a process for approximating periodic features, such as the number of folds 130 as introduced into the plastic foil 114, 118 in an undulating shape over at least one specific section of the outer packaging 116, in particular by employing a Canny Transformation or a filter according to Sobel, Prewitt, Roberts, Marr-Hildreth and/or Haralick. For this purpose, it may be advantageous to select the sections 150 within the outer packaging 116 in a manner that they exhibit a variation being above or below an average variation observable over one or more sides 129 of the outer packaging 116.

As a preferred example, the number 158 of the folds 130 within the selected section 150 of the outer packaging 116 may be counted. In addition, further corresponding properties of the folds 130, such as a frequency of the undulating shape, may be identified in more detail by applying a Fourier Transformation, more particular a Fast Fourier Transformation (FFT), of the respective sections 150 Similarly, a number of the stains 136, such as the number of the fingerprints 138, within the selected section 150 of the outer packaging 116 may be counted.

As a further example, two or more sections 150 on the outer packaging 116 may be compared with each other with regard to their corresponding transparency and/or color within the sections 150 in order to record the respective variation 132 which may be indicative of the corresponding thickness of the plastic foil 114, 118 within the sections 150 after the modification 124.

As mentioned above in more detail, other kinds of deriving the individual imperfection profile 156 from the respective features 126 in the outer packaging 116 may be applied, such employing one or more variation of the features 126 over one or more sections 150 in the picture 148 of the outer packaging 116.

Further, the proving apparatus 140 comprises a storing device 160 for storing the at least one reference, in particular a transformation of at least one of the pictures 148 and/or the individual imperfection profile 156, for further use.

In a first example (not depicted here), the storing device 160 may comprise a label 128 which is attached to the outer packaging 116 and which is configured for carrying the respective information.

However, in the example as shown here, the individual imperfection profile 156 is transferred to the storing device 160 by means of a further transmission line 162, which may be wire-bound, wire-less or within a computer network, wherein the storing device 160 is adapted for generating a database record 164 in a database 166, wherein the database record 164 is related to the outer packaging 116 under investigation. In this particular example, each database record 164 comprises at least an identifier as a further reference 168 and the individual imperfection profile 156, wherein both the further reference 168, which may comprise an identification number of the outer packaging 116, and the individual imperfection profile 156 are related to the outer packaging 116 in a manner that they allow uniquely identifying both the outer packaging 116 and its integrity status 142 over the complete supply chain.

In further first example (also not depicted here), the storing device 160 may comprise a physically separate storage device, preferably an RFID chip, a USB chip, or a magnetic stripe, which may be attached to the at least one pallet 112, wherein the at least one reference may be stored in the storing device 160 for further use.

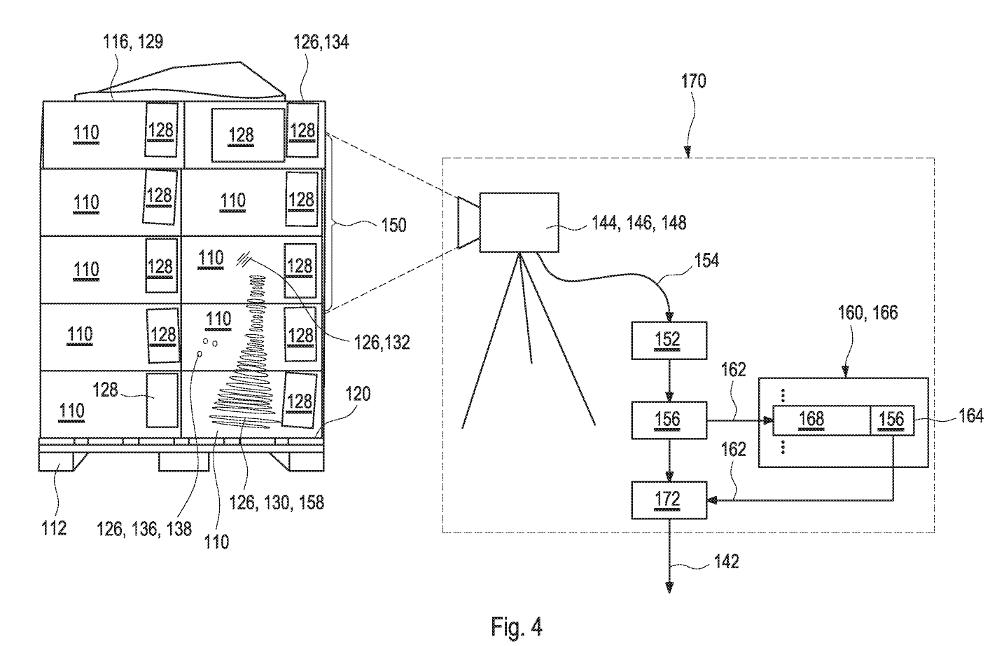

FIG. 4 schematically depicts a preferred determining apparatus 170 which is particularly configured for performing the method for determining the integrity status 142 of a suspect outer packaging 116. In this particular example, the determining apparatus 170 also comprises the camera 144 as the recording device 146 being adapted for recording one or more pictures 148 of one or more sections 150 at one or more sides 129 of the outer packaging 116.

Further, the determining apparatus 170 again comprises the analysis device 152 being configured for analyzing the pictures 148 of the sections 150 for retrieving at least one reference to one or more features 126 as introduced during the modification 124 of the plastic foil 114, 118 constituting the outer packaging 116. Also here, the pictures 148 of the sections 150 are transferred from the recoding device 146 to the analysis device 152 by the transmission line 154. Accordingly, at least one of the pictures 148 of the sections 150 may be used as the at least one reference. Herein, a transformation of the pictures 148 may be performed, wherein the transformation may comprise one of the transformation processes as described above in more detail. Alternatively or in addition, from a quantity which is related to the features 126 as developed in the outer packaging 116 as a result of the modification 124 of the plastic foil 114, 118, an individual packaging profile 156 of the outer packaging 116 may be derived as a corresponding numerical value which may constitute or contribute to the at least one reference.

In contrast to the proving apparatus 140, the determining apparatus 170 further comprises a comparing device 172 which is configured for comparing the at least one reference with respect to the suspect outer packaging 116, in particular the at least one transformation of the pictures 148 and/or the least the individual packaging profile 156, with the at least one reference with respect to the original outer packaging 116, in particular the at least one transformation of the pictures 148 and/or the individual packaging profile 156 of the original outer packaging 116, which have been stored for further use in the storing device 160 as described above. As already mentioned above, the comparison is preferably performed in a manner that it takes into account any tolerance levels within which the integrity of the suspect outer packaging may be still assumed, wherein the tolerance levels consider inevitable adverse effects, such as deterioration, ageing, dirt, color residues, or wear, which may affect the outer packaging 116 during its storage and/or transport.

By this comparison the integrity status 142 of the suspect outer packaging 116 is finally determined. Since a further modification of the plastic foil 114, 118 which constitutes the outer packaging 116 usually further modifies the plastic foil 114, 118 with respect to the features 126 comprised within the at least one reference with respect to of the outer packaging 116, in particular in the at least one transformation of the pictures 148 and/or in the least the individual packaging profile 156. Thus, the pictures 148 and the individual imperfection profile 156 of the outer packaging 116 are very likely to be altered so that, consequently, a the comparing device 172 may provide a result being indicative of a tampering of the outer packaging 116 in the time interval between the two or more distinct pictures 148 which have been recorded for the same section 150 of the corresponding outer packaging 116.

### LIST OF REFERENCE NUMBERS

110 item
112 pallet
114 foil
116 outer packaging
118 plastic foil
120 top of pallet
122 roll of foil
124 modification
126 feature
128 label
129 side
130 fold
132 variation
134 edge
136 stain
138 fingerprint
140 proving apparatus
142 integrity status
144 camera
146 recording device
148 picture
150 section
152 analysis device
154 transmission line
156 individual packaging profile
158 number of folds
160 storing device
162 transmission line
164 database record
166 database
168 further reference
170 determining apparatus
172 comparing device

While this invention has been described as having an exemplary design, the present invention may be further modified within the spirit and scope of this disclosure. This application is therefore intended to cover any variations, uses, or adaptations of the invention using its general principles.

What is claimed is:

1. A method for proving an integrity status of an original outer packaging, wherein the outer packaging covers an item, wherein the outer packaging is formed by a modification of a foil provided for the outer packaging, wherein the proving comprises acquiring and storing a reference to a feature introduced by the modification into the foil, wherein the outer packaging is uniquely identifiable by using the reference, the method comprising the following steps:
a) recording a picture of a section of the outer packaging;
b) analyzing in the picture the reference to a feature introduced by the modification into the foil; and
c) storing the reference with respect to the original outer packaging as the integrity status of the original outer packaging for further use.

2. The method of claim 1, wherein the modification of the foil is introduced into the foil by at least one of wrapping, stretching, or shrinking the foil around the item.

3. The method of claim 1, wherein the feature of the modification of the foil to which the reference is related to is selected from the picture of the section of the outer packaging from one or more of: a fold; a variation of a transparency; a variation of a color; a property of an edge; a stain; a variation of the feature over the a section of the outer packaging.

4. The method of claim 3, wherein the feature is the fold and wherein the fold comprises an undulated shape developed in a part of the outer packaging during the modification, wherein the undulated shape exhibits a sinusoidal, a wavelike or a rippled form, wherein the undulated shape is perpendicular to a surface of the foil in a portion of the outer packaging.

5. The method of claim 3, wherein the feature is the stain and wherein the stain comprises a modification in a location on the outer packaging, wherein an amount of dirt, sweat, color residues, or a fingerprint, is placed in the location.

6. The method of claim 1, wherein the reference is selected from one or more of: the picture of the section of the outer packaging, wherein the section comprises the feature; and a quantity acquired for the feature as comprised in the picture of the section of the outer packaging.

7. The method according to claim 1, wherein the item is arranged on a pallet, wherein the outer packaging covers the item and at least a part of the pallet.

8. The method of claim 1, wherein the item is selected from one or more of: a physical object; an accompanying article, such as a label, or a document; an inner packaging in form of a primary packaging, such as a bottle, a syringe, a vial, an ampoule, a carpule, a blister; the inner packaging in form of a secondary packaging, such as a folding box, a hangtag, or a cardboard box.

9. A method for determining an integrity status of a suspect outer packaging, wherein the outer packaging covers an item, wherein the outer packaging is formed by a modification of a foil provided for the outer packaging, wherein the outer packaging is suspect of a tampering, the method comprising the following steps:
a) recording a picture of a section of the outer packaging;
b) analyzing in the picture a reference to a feature introduced by the modification into the foil being suspect of a further modification by the tampering of the outer packaging;
d) comparing the reference with respect to the suspect outer packaging with a reference with respect to an original outer packaging as stored for further use according to claim 1, by which comparison the integrity status of the suspect outer packaging is determined.

10. The method of claim 9, wherein the modification of the foil is introduced into the foil by at least one of wrapping, stretching, or shrinking the foil around the item.

11. The method of claim 9, wherein the feature of the modification of the foil to which the reference is related to is selected from the picture of the section of the outer packaging from one or more of: a fold; a variation of a transparency; a variation of a color; a property of an edge; a stain; a variation of the feature over the section of the outer packaging.

12. The method of claim 11, wherein the feature is the fold and wherein the fold comprises an undulated shape developed in a part of the outer packaging during the modification, wherein the undulated shape exhibits a sinusoidal, a wavelike or a rippled form, wherein the undulated shape is perpendicular to a surface of the foil in a portion of the outer packaging.

13. The method of claim 11, wherein the feature is the stain and wherein the stain comprises a modification in a location on the outer packaging, wherein an amount of dirt, sweat, color residues, or a fingerprint, is placed in the location.

14. The method of claim 9, wherein the reference is selected from one or more of: the picture of the section of the outer packaging, wherein the section comprises the feature; a quantity acquired for the feature as comprised in the picture of the section of the outer packaging.

15. The method of claim 9, wherein the item is arranged on a pallet, wherein the outer packaging covers the item and at least a part of the pallet.

16. The method of claim 9, wherein the item is selected from one or more of: a physical object; an accompanying article, such as a label, or a document; an inner packaging in form of a primary packaging, such as a bottle, a syringe, a vial, an ampoule, a carpule, a blister; the inner packaging in form of a secondary packaging, such as a folding box, a hangtag, or a cardboard box.

17. A proving apparatus for proving an integrity status of an original outer packaging, wherein the outer packaging covers an item, wherein the outer packaging is formed by a modification of a foil provided for the outer packaging, wherein the proving comprises acquiring and storing a reference to a feature introduced by the modification into the foil, wherein the outer packaging is uniquely identifiable by using the reference, the proving apparatus comprising:
A) a recording device configured for recording a picture of a section of the outer packaging;
B) an analyzing device configured for analyzing in the picture the reference to a feature introduced by the modification into the foil;
C) a storing device for storing the reference with respect to the original outer packaging as the integrity status of the original outer packaging for further use.

18. The apparatus of claim 17, wherein the recording device comprises an optical element which is selected from the group comprising: a camera, a flatbed scanner, a bar code hand-scanning device, a laptop webcam, a cell phone, a smartphone, a tablet computer.

19. A determining apparatus for determining an integrity status of a suspect outer packaging, wherein the outer packaging covers an item, wherein the outer packaging is formed by a modification of a foil provided for the outer packaging, wherein the outer packaging is suspect of a tampering, the determining apparatus comprising:
A) a recording device configured for recording a picture of a section of the outer packaging;
B) an analyzing device configured for analyzing in the picture the reference to a feature introduced by the modification into the foil;
D) a comparing device configured for comparing the reference with respect to the suspect outer packaging with a reference with regard to an original outer packaging as acquired from a proving apparatus of claim 17, by which comparison the integrity status of the suspect outer packaging is determined.

20. The apparatus of claim 19, wherein the recording device comprises an optical element which is selected from the group comprising: a camera, a flatbed scanner, a bar code hand-scanning device, a laptop webcam, a cell phone, a smartphone, a tablet computer.
